(19) United States
(12) Patent Application Publication
(10) Pub. No.: US 2026/0163936 A1
(43) Pub. Date: Jun. 11, 2026

(54) METHOD AND SYSTEM FOR MANAGING DATA

(71) Applicants: HYUNDAI MOTOR COMPANY, Seoul (KR); KIA CORPORATION, Seoul (KR)

(72) Inventors: Hyunseon Chae, Hwaseong-si (KR); Sae Yong Jang, Hwaseong-si (KR)

(73) Assignees: HYUNDAI MOTOR COMPANY, Seoul (KR); KIA CORPORATION, Seoul (KR)

(21) Appl. No.: 19/408,007

(22) Filed: Dec. 3, 2025

(30) Foreign Application Priority Data
Dec. 6, 2024 (KR) 10-2024-0180864

(51) Int. Cl. H04L 67/02

(52) U.S. Cl. CPC H04L 67/02

(57) ABSTRACT

A data management method is performed by a data converter including a processor and a memory, and an application programming interface (API) server of a data management system. The data management method includes collecting data related to the vehicle as a CAN message through a controller area network (CAN) channel within the vehicle by the data converter; converting the CAN message into a hypertext transfer protocol (HTTP) format including an updated value based on pre-arranged matching information by the data converter; sending an update request to the API server via a HTTP POST method for the converted value by the data converter; and providing an HTTP format data corresponding to a vehicle data request to the application device by the API server when the vehicle data request is received from an application device via an HTTP GET method.

### CROSS-REFERENCE TO RELATED APPLICATION

This application claims priority to and the benefit of Korean Patent Application No. 10-2024-0180864, filed in the Korean Intellectual Property Office on Dec. 6, 2024, the entire disclosure of which is incorporated herein in its entirety by reference.

### BACKGROUND

### (a) Technical Field

The disclosure relates to a data management method and a data management system. More specifically, the disclosure relates to a data management method and system specifically configured to convert vehicle data based on a CAN (Controller Area Network) communication protocol inside a vehicle into another protocol and providing the same to an outside recipient.

### (b) Description of the Related Art

With the development of purpose-built vehicles, there is a growing need for access to vehicle data by outside recipients, e.g., outside terminals or data clients. However, vehicle data is mainly managed within/inside the vehicles via the CAN communication protocol. Remote recipients may have difficulty accessing the vehicle data due to a lack of understanding or access to the specific CAN communication protocol format and structure used within the vehicle.

### SUMMARY

The disclosed embodiments provide a technical solution for allowing remote access to vehicle data. In particular, the disclosed embodiments relate to a data management method and system that convert/transform in-vehicle data into a different protocol and provides the different protocol to outside recipients. Specifically, the disclosed embodiments provide an API (Application Programming Interface) service based on real-time vehicle data to outside recipients.

A data management method according to an embodiment may be performed by a data converter including a processor and a memory, and an application programming interface (API) server connected to the data converter through a network. The data management method may include collecting, by a data converter implemented by a processor, data related to the vehicle as a CAN message through a controller area network (CAN) channel within the vehicle; converting, by the data converter, the CAN message into a hypertext transfer protocol (HTTP) format including a converted value based on pre-arranged matching information; sending, by the data converter, an update request to an application programming (API) server via an HTTP POST method for the converted value; and providing, by the API server, an HTTP format data corresponding to a vehicle data request to an application device implemented by a controller when the vehicle data request is received from the application device via an HTTP GET method.

In some embodiments, collecting the data related to the vehicle as the CAN message may include filtering and collecting, by the data converter, only the CAN message included in the matching information among a plurality of CAN messages within the vehicle.

In some embodiments, converting the CAN message into HTTP format may include converting the CAN message into an HTTP format only when the content of the CAN message has changed.

In some embodiments, transmitting the update request to the API server may include transmitting the update request to the API server via an HTTP POST method for the converted value only when the content of the CAN message has changed.

In some embodiments, the method may further include updating, by the API server, the converted value in a database when the update request is received from the data converter via HTTP POST.

In some embodiments, providing the HTTP format data to the application device may include searching, by the API server, the database for the value corresponding to the vehicle data request and providing the value to the application device.

In some embodiments, the data converter may be coupled at least one of a drive controller, a body controller and a chassis controller of the vehicle via the CAN.

In some embodiments, the method may further include retrieving the pre-arranged matching information from a table stored in a non-transitory memory. The table may include a CAN channel, a CAN messages, a CAN signal, a CAN values, an API URL (Uniform Resource Locator), an API data names, and an API data values as an attribute.

In some embodiments, the method may further include adding, when a CAN message is added due to a change in specifications of the above vehicle, a new record having a new attribute to the table.

In some embodiments, the method may further include implementing, by the application device, an application related to the vehicle by using the HTTP format data provided from the API server.

A data management system according to an embodiment may include one or more vehicle controller; a data converter implemented by a processor, the data converter configured to be coupled with one or more vehicle controllers via a controller area network (CAN) protocol and to collect a data related to the vehicle as a CAN message via a CAN channel within the vehicle; an application programming interface (API) server configured to be coupled with the data converter through a network; and an application device implemented by a controller and configured to transmit a vehicle data request for collecting information about the vehicle to the API server via a hypertext transfer protocol (HTTP) and implement an application related to the vehicle using a HTTP format data provided from the API server.

In some embodiments, the data converter may be configured to convert the CAN message into a HTTP format according to a pre-arranged matching information.

In some embodiments, the data converter may be further configured to filter and collect only the CAN message included in the matching information among a plurality of CAN messages within the vehicle.

In some embodiments, the data converter may be further configured to convert the CAN message into HTTP format only when the content of the CAN message has changed.

In some embodiments, the data converter may be configured to transmit an update request to the API server via the HTTP POST method for the converted value.

In some embodiments, when the update request is received via a HTTP POST from the data converter, the API server may be configured to update the converted value in a database.

In some embodiments, the API server may be configured to search the database for a value corresponding to the vehicle data request to be provided to the application device.

In some embodiments, the application device may be configured to transmit the vehicle data request to the API server via the HTTP GET method. The API server may be configured to provide the HTTP format data corresponding to the vehicle data request to the application device.

In some embodiments, the pre-arranged matching information may be retrieved from a table, and the table may include a CAN channel, a CAN message, a CAN signal, a CAN value, an API URL (Uniform Resource Locator), an API data name, and an API data value as attributes.

In some embodiments, when a CAN message is added due to a change in a specification regarding the vehicle, a new record having new attributes may be added to the table.

### BRIEF DESCRIPTION OF THE DRAWINGS

FIG. 1 is a diagram illustrating a data management system according to one embodiment.

FIGS. 2 and 3 are views illustrating an implementation of a data management method and a data management system according to one embodiment.

FIG. 4 is a view illustrating an implementation of a data management method and a data management system according to one embodiment.

FIG. 5 is a view illustrating an implementation of a data management method and a data management system according to one embodiment.

FIG. 6 is a diagram illustrating a data management method according to one embodiment.

FIG. 7 is a diagram illustrating a computing device according to one embodiment.

### DETAILED DESCRIPTION

Various embodiments of the present disclosure are described below in detail with reference to the accompanying drawings. As those of ordinary skill in the art would realize, the described embodiments may be modified in various ways, all without departing from the spirit or scope of the present disclosure. Accordingly, the drawings and description are to be regarded as illustrative in nature and not restrictive. In the following drawings, the same reference numerals are used throughout to designate the same or equivalent elements, even though the elements are shown in different drawings.

In addition, unless explicitly described to the contrary, the word “comprise”, and variations such as “comprises” or “comprising”, should be understood to imply the inclusion of stated elements but not the exclusion of any other elements. Terms including ordinal numbers such as first, second, and the like are solely used to differentiate one component from other components but not to imply or suggest the type, order, or sequence of the components.

Terms “-er”, “-or”, and “module” described in the specification refer to units for processing at least one function and operation and may be implemented by hardware components or software components and combinations thereof. In addition, at least some configurations or functions of file conversion methods and devices according to various embodiments described below may be implemented as a program, software, or computer-executable instructions. The program, software, or computer-executable instructions may be stored in a computer-readable recording medium, storage medium, or non-transitory memory. When a component, device, element, part, unit, module or the like of the present disclosure is described as having a purpose or performing an operation, function, or the like, the component, device, or element should be considered herein as being “configured to” meet that purpose or to perform that operation or function. Each “part”, “unit”, “module”, “component”, “device”, “element”, and the like may separately embody or be included with a processor and a memory, such as a non-transitory computer readable media, as part of the apparatus.

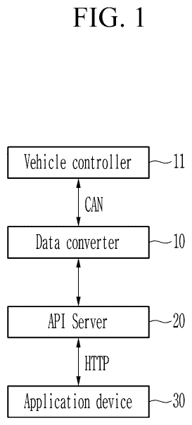

FIG. 1 is a diagram illustrating a data management system according to one embodiment.

Referring to FIG. 1, a data management system according to one embodiment may include a data converter 10, one or more vehicle controllers 11, an API (Application Programming Interface) server 20, and an application device 30.

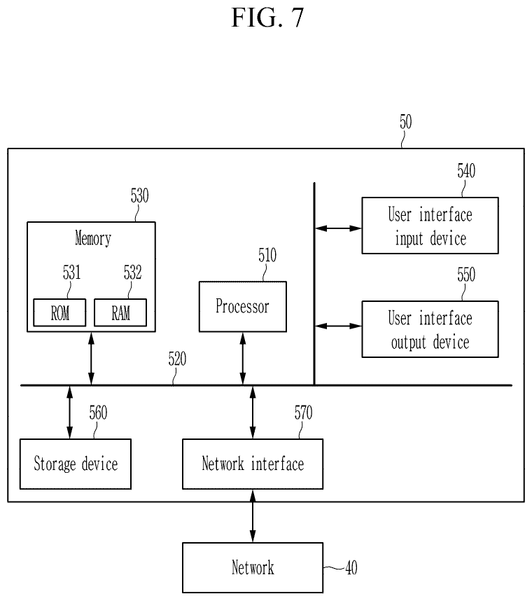

The data converter 10, the vehicle controller 11, the API server 20, and the application device 30 may each execute program codes or computer-executable instructions stored in one or more memory devices through one or more processors. For example, the data converter 10, the vehicle controller 11, the API server 20, and the application device 30 may be implemented as a computing device 50 as described below with respect to FIG. 7. Here, the computing device 50 may be implemented within the vehicle 1, for example, implemented as a controller installed on the vehicle 1. In various embodiments, the application device 30 may be implemented within the vehicle 1, but may also be implemented as the computing device 50 outside the vehicle 1. In this case, one or more processors of each of the data converter 10, the vehicle controller 11, the API server 20, and the application device 30 may be implemented by the processor 510 of the computing device 50, and one or more memory devices may correspond to the memory 520 of the computing device 50 as shown in FIG. 7. The program code or the computer-executable instructions may be executed by one or more processors to perform the operations of the data management system.

The data converter 10 may be implemented within the vehicle 1. The data converter 10 may exchange data with one or more vehicle controllers 11 implemented together within the vehicle 1 through an internal network. In an embodiment, the internal network may use a CAN (Controller Area Network) protocol. The CAN is a communication protocol developed to support the data exchange between electronic control units in the vehicle, and may be used, for example, for a real-time data transmission between sensors, actuators, and controllers in the vehicle. The CAN is a message-based protocol that assigns a unique identifier to each data frame to determine a priority and may transmit and receive a data at a speed of up to 1 Mbps. A data transmission unit consists of a CAN message with a payload of up to 8 bytes, which may be expanded up to 64 bytes using a CAN FD (Flexible Data-rate) technology.

One or more vehicle controllers 11 may include, for example, a drive controller, a body controller, a chassis controller, and the like, but the scope of the present disclosure is not limited to those listed. The drive controller 11 is a controller responsible for the overall control of the power transmission system of the vehicle and may perform functions such as a motor control, a battery management, and a power efficiency optimization. The body controller is a controller that manages and controls various functions related to the vehicle's body system and may be in charge of systems related to the convenience of the driver and the passengers and the safety of the vehicle, such as a vehicle lighting (headlights, interior lights), a window control, door locks, an air conditioning, and wipers. The chassis controller may provide a function to support an electronic steering input and improve a steering accuracy and a stability or control the steering of the vehicle to enhance a driving safety.

In other words, the data converter 10 may be connected to or coupled with one or more vehicle controllers 11 through the CAN protocol. The data converter 10 may collect the vehicle-related data as the CAN message through a CAN channel within the vehicle. Here, the CAN message is a data transmission unit used for the in-vehicle communication. The CAN message may include a start of frame (SOF), an arbitration field, a control field, a data field, a cyclic redundancy check (CRC) field, an ACK (ACKnowledge) field, and an end of frame (EOF). The API server 20 may be connected to the data converter 10 via a network.

The application device 30 may exchange the data with the API server 20 via a hypertext transfer protocol (HTTP). The application device 30 may transmit a vehicle data request for collecting an information about the vehicle to the API server 20 via the HTTP, and implement an application related to the vehicle using an HTTP format data provided from the API server 20.

The data converter 10 may collect vehicle-related data from a CAN message through the CAN channel within the vehicle. In some embodiments, when collecting the CAN messages related to the vehicle, the data converter 10 may filter and collect only the CAN messages included in a matching information among the CAN messages within the vehicle. The matching information may refer to pre-arranged correspondence information that defines the relationship between a CAN channel, a CAN message, a CAN signal, and a CAN value received through in-vehicle CAN communication, and an API URL, an API data name, and an API data value used for communication with an external server or application. The matching information may be managed in a table format and serves as reference information that enables the data converter to determine which API data the received CAN message should be converted into.

The data converter 10 may convert the CAN message into the HTTP format according to pre-arranged matching information. HTTP is the basic communication protocol for exchanging the data between clients and servers on the web. HTTP may be used to request and transmit a content such as HTML, images, and videos between clients and web servers. HTTP may operate in the form of requests and responses. The pre-arranged matching information may be managed in a table stored in a non-transitory memory. Specifically, the table may be designed to have CAN channels, CAN messages, CAN signals, CAN values, Uniform Resource Locator (URL) of the API, API data names, and API data values as attributes. The pre-arranged information may be retrieved from the table.

In some embodiments, the data converter 10 may, based on the pre-arranged matching information in the form of the table, convert the CAN message to the HTTP format only when the content of the CAN message has changed. In some embodiments, when the CAN message is added due to a specification change regarding the vehicle, a new record with the corresponding attribute may be added to the table.

The data converter 10 may transmit an update request to the API server 20 by converting the CAN message into HTTP format using the HTTP POST method. Here, the HTTP POST method is used for the client to transmit the data to the server. The transmitted data may be included in the body of the HTTP request and transmitted to the server. In some embodiments, when the data converter 10 transmits an update request to the API server 20, the data converter may transmit the converted value to the API server 20 via the HTTP POST method only when the content of the CAN message has changed.

Thereafter, when the vehicle data request is received from the application device via the HTTP GET method, the API server 20 may provide the HTTP format data corresponding to the vehicle data request to the application device 30. Here, if the HTTP GET method is used by the client to retrieve the data stored on the server, the request data may be included in a query string of an URL. The server may return the data upon the request. In some embodiments, when the update request is received via the HTTP POST from the data converter 10, the API server 20 may update the converted value in the database. In some embodiments, the API server 20 may search for the value corresponding to a vehicle data request in the database and provide the value to the application device 30 to provide the HTTP format data to the application device 30.

The application device 30 may implement the vehicle-related application using the HTTP format data provided from the API server 20.

According to this embodiment, the vehicle data following the CAN protocol inside the vehicle is converted into HTTP and provided to an external device such as an application device, thereby allowing the external device to easily obtain the real-time vehicle data and provide various API services.

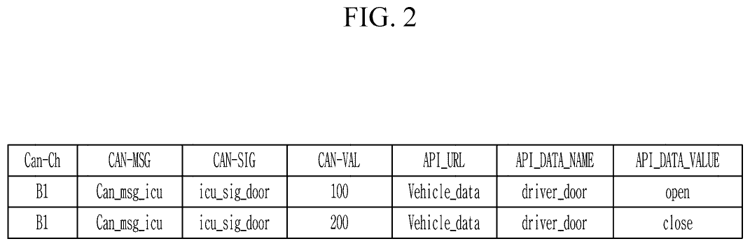

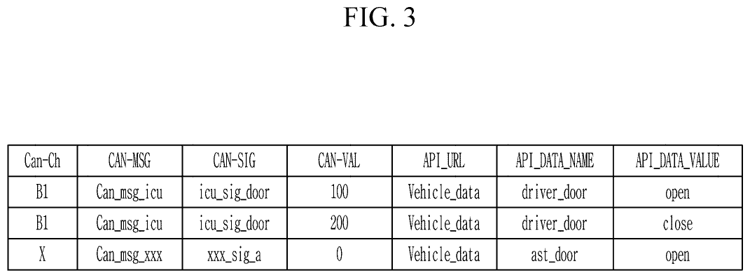

FIGS. 2 and 3 are views illustrating an implementation of a data management method and a data management system according to one embodiment.

Referring to FIG. 2, an example of an implementation of the pre-arranged matching information managed in a table format is illustrated. The table including the pre-arranged matching information may have a CAN channel (Can-ch), a CAN message (CAN-MSG), a CAN signal (CAN-SIG), a CAN value (CAN-VAL), an API URL (API_URL), an API data name (API_DATA_NAME), and an API data value (API_DATA_VALUE) as attributes. The table may be stored in non-transitory memory such as the memory 530 shown in FIG. 7.

For example, in the first row of the table, a CAN message identified as ‘Can_msg_icu’ transmitted on a CAN channel identified as ‘B1’ may include a CAN signal called ‘icu_sig_door’ and a CAN value thereof may be ‘100’. The CAN message may be matched to the API data name ‘driver_door’ and the API data value ‘open’ in the URL of the API called ‘Vehicle_data’. The data converter 10 may convert the CAN message identified as ‘icu_sig_door’ and ‘100’ into the HTTP format by matching it to the API data identified as ‘driver_door’ and ‘open’.

In the second row of the table, the CAN message identified as ‘Can_msg_icu’ transmitted on the CAN channel identified as ‘B1’ may include the CAN signal called ‘icu_sig_door’ and the CAN value thereof may be ‘200’. The CAN message may be matched to the API data name ‘driver_door’ and the API data value ‘close’ in the URL of the API called ‘Vehicle_data’. The data converter 10 may convert the CAN message identified as ‘icu_sig_door’ and ‘200’ into the HTTP format by matching it with the API data matched as ‘driver_door’ and ‘close’.

Referring to FIG. 3, in an embodiment, the CAN message may be added according to a specification change regarding the vehicle. For example, in the third row of the table, the CAN message identified as ‘Can_msg_xxx’ transmitted on the CAN channel identified as ‘X’ includes the CAN signal called ‘xxx_sig_a’ whose CAN value may be ‘0’. The CAN message may be matched to the API data name ‘ast_door’ and the API data value ‘open’ in the URL of the API called ‘Vehicle_data’, and the data converter 10 may convert the CAN message identified as ‘xxx_sig_a’ and ‘0’ into the HTTP format by matching it to the API data identified as ‘ast_door’ and ‘open’.

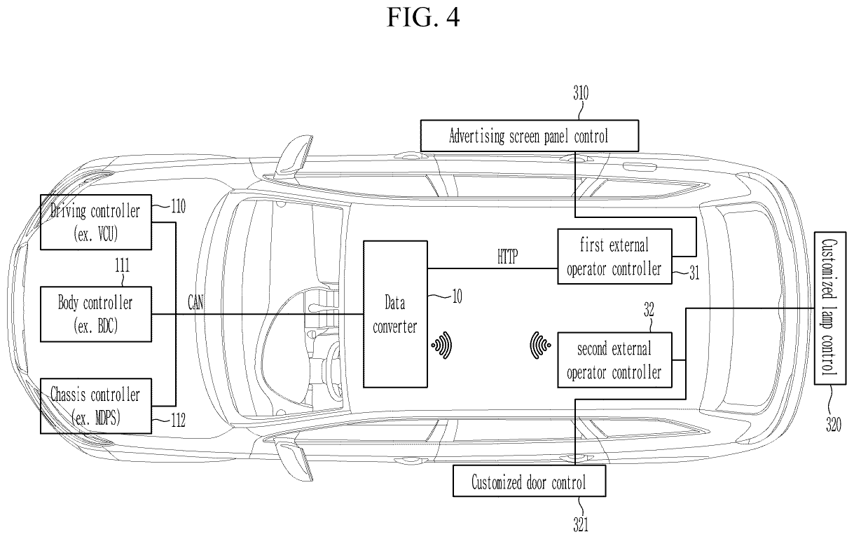

FIG. 4 is a view illustrating an implementation of a data management method and a data management system according to one embodiment.

Referring to FIG. 4, the data converter 10 may be connected to, i.e., coupled with, at least one of a vehicle's drive controller 110, a body controller 111, and a chassis controller 112 via the CAN protocol. The data converter 10 may collect or receive CAN messages including vehicle-related data via the CAN channel.

In some embodiments, an external operator, e.g., an external recipient, an external terminal, an external computer device, and the like, may include a plurality of external operator controllers including a first external operator controller 31 and a second external operator controller 32. The first external operator controller 31 may receive the vehicle-related data from the data converter 10 in the HTTP format through the API server. The first external operator controller 31 may use a wired communication. The second external operator controller 32 may also receive the vehicle-related data from the data converter 10 as the HTTP format data through the API server and the second external recipient controller 32 may use a wireless communication.

The first external operator controller 31 may implement a first application (310) that controls an advertising screen panel by using the vehicle-related data provided via HTTP. For example, the first application 310 may control the advertising screen panel by using the vehicle driving information and the current location among the vehicle-related data provided via HTTP. The second external operator controller 32 may implement a second application 320 for a customized lamp control and a third application 321 for a customized door control by using the vehicle-related data provided via HTTP. In an embodiment, the second and third applications 320 and 321 may receive the vehicle status to control the doors and the lamps. The external operator controllers including the first external recipient controller 31 and the second external operator controller 32 may be configured to be implemented to be mounted in a vehicle.

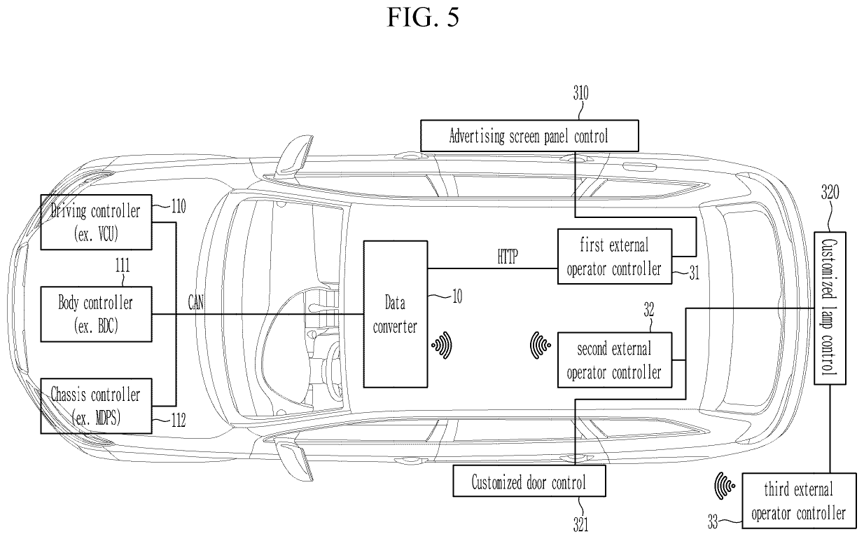

FIG. 5 is a view illustrating an implementation of a data management method and a data management system according to one embodiment.

Referring to FIG. 5, the data converter 10 may be connected to at least one of the drive controller 110, the body controller 111, and the chassis controller 112 of the vehicle via the CAN protocol. The data converter 10 may collect CAN messages including vehicle-related data via the CAN channel. As shown in FIG. 5, a plurality of external operator controllers may include a first operator recipient controller 31, a second operator recipient controller 32, and a third operator recipient third controller 33.

The first external operator controller 31 may receive the vehicle-related data from the data converter 10 in the HTTP format through the API server. The first external operator controller 31 may use wired communication. The second and third external recipient controllers 32 and 33 may also receive the vehicle-related data from the data converter 10 as the HTTP format data through the API server. The second and third external operator controllers 32 and 33 may use the wireless communication.

The first external operator controller 31 may implement the first application 310 that controls the advertising screen panel by using the vehicle-related data provided via the HTTP. The external operator controller 32 may implement the second application 320 for the customized lamp control and the second application 321 for the customized door control using vehicle-related data provided via HTTP. The external operator controllers 31 and 32 may be implemented to be mounted in the vehicle.

The external operator controller 33 may implement the second application 320 for the customized lamp control by using the vehicle-related data provided via the HTTP. The external operator controller 33 may be implemented outside the vehicle.

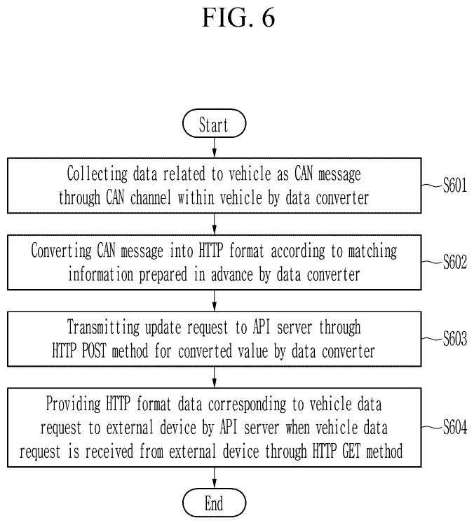

FIG. 6 is a diagram for explaining a data management method according to one embodiment.

Referring to FIG. 6, a data management method according to an embodiment may include collecting data related to the vehicle from a CAN message received via a CAN channel within the vehicle by a data converter (S601), converting the CAN message into an HTTP format including a converted value based on pre-arranged matching information prepared in advance by the data converter (S602), transmitting an update request to an API server through an HTTP POST method for the converted value by the data converter (S603), and providing the HTTP format data corresponding to the vehicle data request to an external device by the API server when the vehicle data request is received from the external device through an HTTP GET method (S604).

For more detailed information on the data management method, reference may be made to the various embodiments included in this specification.

FIG. 7 is a diagram illustrating a computing device according to one embodiment.

Referring to FIG. 7, the data management method and the data management system according to the various embodiments may be implemented using a computing device 50. The computing device 50 may be implemented as various types of electronic devices, servers or similar devices, and their functions may be implemented through a combination of software and hardware.

The computing device 50 may include at least one of a processor 510, a non-transitory memory 530, a user interface input device 540, a user interface output device 550, and a storage device 560 communicating via a bus 520. The computing device 50 may also include a network interface 570 electrically connected to a network 40. The network interface 570 may transmit or receive signals with other entities via the network 40.

The processor 510 may be implemented as various types of computational units, such as an MCU (Micro Controller Unit), an AP (Application Processor), a CPU (Central Processing Unit), a GPU (Graphic Processing Unit), an NPU (Neural Processing Unit), a QPU (Quantum Processing Unit), etc. The processor 510 is a semiconductor device that executes instructions stored in the memory 530 or a storage device 560 and may play a key role in the system. Program codes, computer-executable instructions, and data stored in the memory 530 or the storage device 560 instruct the processor 510 to perform specific tasks, thereby enabling the overall operation of the system. The processor 510 may be configured to implement various functions and methods described above with respect to FIGS. 1-6.

The memory 530 and the storage device 560 may include various forms of volatile or non-volatile storage media for storing and accessing the data of the system. For example, the memory 530 may include a read-only memory (ROM) 531 and a random-access memory (RAM) 532. In some embodiments, the memory 530 may be built into the processor 510, in which case data transfer speeds between the memory 530 and the processor 510 may be very fast. In some other embodiments, the memory 530 may be located external to the processor 510, in which case the memory 530 may be connected to the processor 510 via various data buses or interfaces. This connection may be made through a variety of already known interfaces such as the Peripheral Component Interconnect Express (PCIe) interface for high-speed data transfer or through a memory controller.

In some embodiments, at least some components or functions of the data management methods and data management systems according to the embodiments may be implemented as a program, software, or computer-executable instructions executed by a computing device 50, and the program, software, or computer-executable instructions may be stored on a computer-readable recording medium, storage medium, or non-transitory memory. Specifically, a computer-readable recording medium or storage medium according to an embodiment may be a computer having recorded thereon a program for causing a computer including a processor 510 to execute a program, command, or computer-executable instruction stored in a memory 530 or a storage device 560 to execute steps included in the implementation of a data management method and a data management system according to the embodiments.

In some embodiments, at least some components or functions of the data management methods and data management systems according to the embodiments may be implemented using hardware or circuitry of the computing device 50 or may be implemented as separate hardware or circuitry that can be electrically connected to the computing device 50.

According to embodiments, the vehicle data following the CAN protocol inside the vehicle is converted into the HTTP protocol and provided to an external device such as an application device, thereby allowing the external device to easily obtain the real-time vehicle data and provide various API services.

While this disclosure has been described in connection with various embodiments, a person of ordinary skill in the art would understand that the disclosure is not limited to the disclosed embodiments. On the contrary, the present disclosure is intended to cover various modifications and equivalent arrangements included within the spirit and scope of the appended claims.

What is claimed is:

1. A data management method comprising:
collecting, by a data converter implemented by a processor, data related to a vehicle as a CAN message through a controller area network (CAN) channel within the vehicle;
converting, by the data converter, the CAN message into a hypertext transfer protocol (HTTP) format including a converted value based on pre-arranged matching information;
sending, by the data converter via a network, an update request to an application programing (API) server via an HTTP POST method for the converted value; and
providing, by the API server, an HTTP format data corresponding to a vehicle data request to an application device implemented by an external operator controller when the vehicle data request is received from the application device via an HTTP GET method.

2. The data management method of claim 1, wherein collecting the data related to the vehicle as the CAN message includes:
filtering and collecting, by the data converter, only the CAN message included in the pre-arranged matching information among a plurality of CAN messages within the vehicle.

3. The data management method of claim 1, wherein converting the CAN message into the HTTP format includes:
converting the CAN message into the HTTP format only when a content of the CAN message has changed.

4. The data management method of claim 3, wherein transmitting the update request to the API server includes:
transmitting the update request to the API server via an HTTP POST method for the converted value only when the content of the CAN message has changed.

5. The data management method of claim 1, further comprising:
updating, by the API server, the converted value in a database when the update request is received from the data converter via HTTP POST.

6. The data management method of claim 5, wherein providing the HTTP format data to the application device includes:
searching, by the API server, the database for the value corresponding to the vehicle data request and providing the value to the application device.

7. The data management method of claim 1, wherein:
the data converter is coupled with at least one of a drive controller, a body controller or a chassis controller of the vehicle via the CAN.

8. The data management method of claim 1, further comprising:
retrieving the pre-arranged matching information from a table stored in a non-transitory memory, wherein the table includes a CAN channel, CAN messages, a CAN signal, CAN values, an API URL (Uniform Resource Locator), API data names, and API data values as an attribute.

9. The data management method of claim 8, further comprising:
adding, when a CAN message is added due to a change in specifications of the vehicle, a new record having a new corresponding attribute to the table.

10. The data management method of claim 1, further comprising:
implementing, by the application device, an application related to the vehicle by using the HTTP format data provided from the API server.

11. A data management system comprising:
one or more vehicle controllers;
a data converter implemented by a processor and configured to be coupled with the one or more vehicle controllers via a controller area network (CAN) protocol and to collect data related to a vehicle included in a CAN message received via a CAN channel within the vehicle from the one or more vehicle controllers;
an application programming interface (API) server configured to be coupled with the data converter through a network; and
an application device implemented by an external operator controller and configured to transmit a vehicle data request for collecting information about the vehicle to the API server via a hypertext transfer protocol (HTTP) and implement an application related to the vehicle using an HTTP format data provided by the API server.

12. The data management system of claim 11, wherein:
the data converter is configured to convert the CAN message into an HTTP format including a converted value based on pre-arranged matching information.

13. The data management system of claim 12, wherein the data converter is configured to filter and collect only the CAN message included in the pre-arranged matching information among a plurality of CAN messages within the vehicle.

14. The data management system of claim 12, wherein the data converter is further configured to convert the CAN message into HTTP format only when a content of the CAN message has changed.

15. The data management system of claim 12, wherein the data converter is configured to transmit an update request to the API server via an HTTP POST method for the converted value.

16. The data management system of claim 15, wherein, based on the update request being received via a HTTP POST from the data converter, the API server is configured to update the converted value in a database.

17. The data management system of claim 16, wherein the API server is configured to search the database for a value corresponding to the vehicle data request to be provided to the application device.

18. The data management system of claim 11,
wherein the application device is configured to transmit the vehicle data request to the API server via an HTTP GET method, and
wherein the API server is configured to provide the HTTP format data corresponding to the vehicle data request to the application device.

19. The data management system of claim 12,
wherein the pre-arranged matching information is retrieved from a table stored in a memory, and
wherein the table includes a CAN channel, a CAN message, a CAN signal, a CAN value, an API URL (Uniform Resource Locator), an API data name, and an API data value as attributes.

20. The data management system of claim 19, wherein when a CAN message is added due to a change in a specification regarding the vehicle, a new record having new attributes is added to the table.
